(19) United States
(12) Patent Application Publication
(10) Pub. No.: US 2003/0071721 A1
(43) Pub. Date: Apr. 17, 2003

(54) Adaptive radiated emission control

(76) Inventors: Constantine N. Manis, Monmouth Junction, NJ (US); Oleg Logvinov, East Brunswick, NJ (US); Mike K. Bautista, Portola Valley, CA (US)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(21) Appl. No.: 10/211,123

(22) Filed: Aug. 2, 2002

Related U.S. Application Data
(60) Provisional application No. 60/310,298, filed on Aug. 4, 2001.

(51) Int. Cl. H04M 11/04

(52) U.S. Cl. 340/310.03

(57) ABSTRACT

An adaptive radiated emission control includes measurement of the transmit power spectrum and feedback to a variable power modulator. The variable power modulator creates an adjusted output spectrum that limits radiated emissions. Alternatively, the variable power modulator may also be an equalizer to adjust the output spectrum.

### RELATED APPLICATIONS

The benefit of priority of the provisional application No. 60/310,298 filed on Aug. 4, 2001 in the names of the inventors, is hereby claimed.

### BACKGROUND OF THE INVENTION

1. Field of the Invention

The present invention relates to controlling radiated emissions for communications systems operating in a network with inconsistent and/or variable impedance. In particular, the invention can be used to control radiated emissions for communication systems operating over powerlines.

2. Description of the Related Art

Although the principles of the invention can be used in connection with other communication systems, the invention will be described in connection with the power line communication systems of the type developed by Enikia, LLC. in New Jersey and described at pages 100-107 of the publication entitled “The Essential Guide to Home Networking Technologies” published in 2001 by Prentice-Hall, Inc., Upper Saddle River, New Jersey, described in copending applications filed Jun. 28, 2000 and entitled Method for Changing Signal Modulation Based on an Analysis of Powerline Conditions and Method for Selecting and Changing Gears in Powerline Networks, the disclosures of the copending applications being incorporated herein by reference.

Numerous powerline communication systems are described in the patents identified in the copending U.S. application Ser. No. 09/290,255.

For several decades, efforts have been made to utilize AC powerlines as communication lines between networks. Powerlines were traditionally reserved to connect a home or business to the electric utility company in order to supply power to the building. Using power lines for communication networks can be extremely advantageous because powerlines are available even in most remote areas, homes and office/business establishments. In addition, most homes and offices are already equipped with multiple electrical power outlets in every room. Thus, doubling up power lines with communication data lines could provide enormous economic benefits and would make traditional communication networks, such as phone lines, cable television and computer data network lines obsolete.

However, powerline networks were originally designed for optimal delivery of electricity and not for data signals. The difference is not trivial. Highly variable and unpredictable levels of impedance, signal attenuation, noise and, generally, radiated emission may create an extremely harsh environment that makes data transmission over power lines challenging.

Radiated emissions from a power line communication system are, of course, unintentional. In most areas, radiated emissions are regulated by local governmental agencies, which set acceptable unintentional emission standards to insure non-interference with other systems. Commercial distribution of products and installations that fail to meet radiated emission limits is typically prohibited.

In cases of network installations, radiated emissions are dependent on the network topology, size of the network, and discontinuities. It was observed that installations in offices and homes (in-home powerline network) are typically worse case environments for controlling radiated emissions. The office and home power line can be modeled as an oversized antenna. As this antenna approaches resonant lengths either between discontinuities or in its entirety, the more it will radiate. The complexity of this antenna is further complicated when one considers the dynamic (i.e. time varying) nature of the discontinuities. Devices added or removed from the power line change the impedance of a discontinuity. Physical topology of the network, physical properties of the electrical cabling, the appliances connected, the behavioral characteristics of the electric current itself, have to be considered. Impedance, that is, the resistance in flow of AC current may change according to the method of connecting devices and appliances. Impedance discontinuities are caused by wire nut connections, switches, wall socket outlets and appliance loads. The impedance for most devices varies between quiescent and active states. All these dynamic variances have an effect on the antenna effect and the radiated emissions.

In addition to the described above challenges variations in impedance are also common in inductive coupling devices. Such devices are used for injection and reception of high frequency (above 10,000 Hz) to and from low and high voltage (above 100V) power distribution network. Such variations typically caused by 50/60 Hz and transient currents flowing through the power conductor inductive coupling is attached to.

These identified problems tend to make prediction and modeling of radiated emissions from power line communication networks very difficult. The classical method of reducing radiated emissions is to reduce the transmit power injected into communication network. However, for a multi-carrier or OFDM communication system, reducing the power for all carriers affects the performance of carriers that do not cause excessive levels of radiated emissions.

A goal of the invention is to overcome the identified radiated emission problems such that a power line communications system meets regulatory requirements without sacrificing performance.

### SUMMARY OF THE INVENTION

One object of the invention is to overcome the identified problems that contribute to the radiated emissions. Another object is to improve and maintain the efficiency of a power line communication system in the environments with variable parameters. An exemplary embodiment of adaptive radiated emission control includes a system by which the transmit power spectrum and feedback to a variable power modulator is measured. Using the measured power spectrum, the variable power modulator creates an adjusted output spectrum that is used to limit radiated emissions.

In yet another embodiment of the invention, an adaptive radiated emission control includes an equalizer instead of a variable power modulator. The equalizer adjusts the output spectrum of a previously created spectrum to limit radiated emissions.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS DETAILED DESCRIPTION

Exemplary embodiments are described with reference to specific configurations. Those skilled in the art will appreciate that various changes and modifications can be made while remaining within the scope of the claims.

In the drawings, wherein like reference numerals delineate similar elements throughout the several views:

FIG. 1 illustrates an embodiment of the invention which includes a modulator with variable power features.

FIG. 2 illustrates another embodiment of the invention which includes an equalizer with variable power features.

### DETAILED DESCRIPTION OF THE PRESENTLY PREFERRED EMBODIMENTS

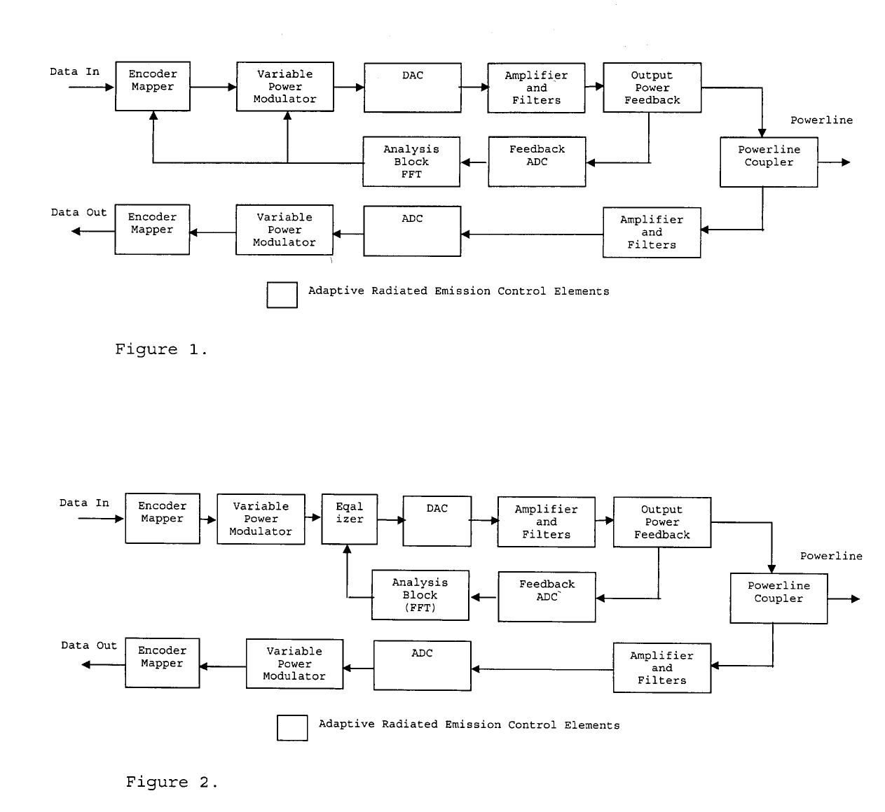

FIG. 1 shows one embodiment for adaptive controlling of radiated emissions according to the invention which utilizes encoder, mapper, and a modulator with variable power features. For a multi-carrier and/or OFDM (Orthogonal Frequency Division Multiplexing) system, the modulator adjusts the power of each carrier based on the information provided by the feedback analysis block. The encoder and mapper block takes into account the information provided by the feedback analysis block for the purpose of constructing a carrier mask, carriers which could not be compensated in the modulator could be entirely removed from the transmit signal. The feedback analysis block processes the feedback data received as the result of operation of the feedback circuit. The feedback circuit measures power output of the transmitter, in the most simplistic way, it could be accomplished by the measurement across the source resistor connected to the output of the transmit amplifier in series with the powerline coupling circuit. The power injected into power line is proportional to the current in the source resistor, and therefore the voltage measured across the resistor can be used as an indication of the output power. Therefore, a carrier with a high power measurement across the source resistor would also be a carrier injecting high power into the power line. The Feedback analysis module interprets this measurement and provides data that is used by encoder, mapper, and modulator to encode, map, and control carrier masking, data mapping, and power levels of the output signal. One of the possible implementations of the feedback analysis block could be based on a FFT (Fast Fourier Transform). The FFT calculates the spectral content of the signal. It moves a signal from the time domain, where it is expressed as a series of time events, to the frequency domain, where it is expressed as the amplitude and phase of a particular frequency.

Limiting carrier power injected into the power line limits the radiated emissions associated with the carrier. Increase of the power on the carriers with lower power output improves signal-to-noise ratio in the powerline network and as the result, improves performance of the system overall.

Each time a unit with adaptive radiated emission control transmits, a power spectrum measurement is made and the output spectrum is adjusted for the current or for the next transmission. Adjustments can be made to decrease and/or increase carrier power to match changing power line conditions. In some cases, a decision can be made to entirely remove the transmission on the problem carrier.

An additional benefit of adaptive radiated emission control is realized by transmit line driver performance. Line driver signal distortion typically increases when driving low source impedance loads. By limiting carrier power, the line driver can avoid driving high power into low source impedance loads, and therefore minimize signal distortion that improves the accuracy and the quality of the transmit signal.

Another benefit of such method is the introduction of the real-time feedback mechanism that allows a system to adapt to rapid changes in the transfer function of the inductive coupling and transmission wire system and/or power distribution system with rapidly changing variable loads. By monitoring and adjusting per-carrier power as well as data mapping and tone masking a powerline communication system improves utilization of the available spectrum and as the result achieves higher levels of transmission reliability and transmission speeds.

Referring to FIG. 2, an alternate embodiment of the invention is illustrated which includes an equalizer instead of a modulator with variable power features.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results be within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. An adaptive radiated emission control system comprising:
a transmit per-carrier power measurement;
a modulator with variable power features for adjusting the transmit power spectrum to limit transmit power and limiting the radiated emissions.

2. The adaptive radiated emission control system according to claim 1, wherein the modulator is an equalizer.

3. The adaptive radiated emission control system according to claim 1, further comprising an encoder and mapper.

4. The adaptive radiated emission control system according to claim 3, further comprising a feedback analysis block providing information to the modulator for adjusting the transmit power.

5. The adaptive radiated emission control system according to claim 4, wherein the encoder and mapper utilize the feedback analysis block for constructing a carrier mask.

6. The adaptive radiated emission control system according to claim 5, further comprising a feedback circuit and wherein the feedback analysis block processes the feedback data from the feedback circuit.

7. The adaptive radiated emission control system according to claim 6, further comprising a transmitter having a power output and wherein the feedback circuit measures the power output of the transmitter.

8. The adaptive radiated emission control system according to claim 7, further comprising a source resistor, and wherein the power output of he transmitter is measured across the source resistor.

9. The adaptive radiated emission control system according to claim 8, further comprising a transmit amplifier connected in series to a power line coupling circuit.

10. The adaptive radiated emission control system according to claim 9, wherein the power injected into the power line is proportional to a current in the source resistor, resulting into an indication of the output power by measuring the voltage across the resistor.

11. The adaptive radiated emission control system according to claim 10, further comprising a feedback analysis module for interpreting the measurement of the voltage across the resistor.

12. The adaptive radiated emission control system according to claim 11, wherein the feedback analysis module provides data utilized by the encoder, mapper and modulator.

13. The adaptive radiated emission control system according to claim 12, wherein the data are uses to encode, map and control carrier masking, data mapping and power levels of the output signal.

14. The adaptive radiated emission control system according to claim 10, wherein the feedback analysis module is a Fast Fourier Transform (FFT).

15. The adaptive radiated emission control system according to claim 14, wherein the FFT calculates the spectral content of the output signal.

16. The adaptive radiated emission control system according to claim 15, wherein the FFT further moves the output signal from a time domain to a frequency domain

17. The adaptive radiated emission control system according to claim 16, wherein the output signal in the time domain is expressed as a series of time events and the signal in the frequency domain is expressed as an amplitude and phase of a frequency.

18. An adaptive power control for improving signal propagation on carriers with high network impedance, comprising a transmit power measurement, and
a modulator with variable power features for adjusting the transmit power spectrum to limit transmit power and limiting the radiated emissions.

19. An adaptive carrier mapping and power control capable of overcoming fluctuation in transfer function in applications involved with inductive coupling, comprising
a transmit power measurement, and
a modulator with variable power features for adjusting the transmit power spectrum to limit transmit power and limiting the radiated emissions.

20. Real-time output power feedback as a way of improvement of system-wide performance a transmit power measurement; comprising
a transmit power measurement, and
a modulator with variable power features for adjusting the transmit power spectrum to limit transmit power and limiting the radiated emissions.

21. An adaptive power control as a way of improving the performance of the front-end circuits, comprising
a transmit power measurement, and
a modulator with variable power features for adjusting the transmit power spectrum to limit transmit power and limiting the radiated emissions.

22. An adaptive power control as a way of improving the performance of the powerline communication system with inductive coupling, comprising
a transmit power measurement, and
a modulator with variable power features for adjusting the transmit power spectrum to compensate for variable impedance arising from 50/60 Hz and transient currents in the power conductor.

23. A method for controlling adaptive radiated emissions for a powerline communications system, comprising the steps of
measuring the spectrum of the transmit power
providing a modulator with variable power features for adjusting the transmit
power spectrum to limit the transmit power.

24. A method for controlling adaptive radiated emissions for a powerline communications system, comprising the steps of
measuring the spectrum of the transmit power
providing an equalizer for adjusting the transmit power spectrum to limit the transmit power.
